(19) United States
(12) Patent Application Publication
(10) Pub. No.: US 2002/0142673 A1
(43) Pub. Date: Oct. 3, 2002

(54) Pair of electric connectors using resin solder in one connector

(75) Inventors: Taiji Hosaka, Yokohama-shi (JP); Masaaki Miyazawa, Kawasaki-shi (JP)

Correspondence Address: FASSE PATENT ATTORNEYS, P.A., P.O. BOX 726, HAMPDEN, ME, 04444-0726, US

(73) Assignee: J.S.T. Mfg. Co., Ltd., Osaka (JP)

(21) Appl. No.: 10/114,196

(22) Filed: Apr. 1, 2002

(30) Foreign Application Priority Data
Mar. 30, 2001 (JP) 2001-102647

(51) Int. Cl. H01R 13/405

(52) U.S. Cl. 439/736

(57) ABSTRACT

One objective of the present invention is to provide electric connectors, which allow passage of a larger current in comparison with terminals formed by MID, can be molded into a variety of configurations according to the applications and do not require the soldering work.

On the pair of electric connectors using resin in one connector according to the present invention, the first electric connector comprises a first housing, which is made of a synthetic resin, and a first terminal, which has a contacting part and a connecting part both being exposed on the surface of the first housing, is integrally formed with the first housing and is made of a lead-free ultrahigh-conductive plastic being a conductive resin composite. The second electric connector comprises a second housing, which is made of an insulating material, and a second terminal, which is made of a conductive material of which elasticity is higher than that of the lead-free ultrahigh-conductive plastic, has a contacting part, which contacts the contacting part of the first terminal, and a connecting part, which is exposed on the surface of the second housing, and is provided with the second housing.

### BACKGROUND OF THE INVENTION

1. Field of the Invention

The present invention belongs to a field of electric connectors, and relates to an electric connector comprising terminals, which use a lead-free ultrahigh-conductive plastic comprising a conductive resin composite, and a counterpart electric connector, which makes a pair with the other electric connector.

2. Related Art

An electric connector generally comprises a housing, which is made of an insulating material, and electric contacts, which are assembled together with the housing. In contrast to it, an electric connector is known, which is produced by a technology called MID (Molded Interconnection Device) (for example, refer to Registered Utility Model gazette no. 2597015). This electric connector comprises a housing, which is made of a synthetic resin, and terminals, which are formed by plating on the surface of the housing. As this electric connector does not require production of the electric contacts independently of the production of the housing, the production cost of the electric connector can be reduced.

The above-mentioned terminals of the conventional electric connector can not be formed into thick terminals because there is a limit in forming a thick plated layer. Hence there is a limit in reducing the resistance of the terminal. This in turn means that a large current can not be passed through the terminal.

The housing of this electric connector must be made of a material which can be plated with. Moreover, although depending on the method of plating, the configuration of the housing is limited. For example, it is necessary to form a part to be plated higher in level the rest and to carefully avoid formation of any parts that give shades against sunlight or laser beams, such as differences in level and overhangs.

When an electric wire is to be connected to a terminal of an electric connector by soldering, the conductor of the electric wire will be placed on the terminal and molten solder will be applied. However, for example, it is difficult or impossible to solder the conductor of the electric wire to a recess in the terminal. Further, this work of applying solder requires delicate quality control, temperature control and the like of the solder, and the control man-hour increases correspondingly.

When the electric wire to be connected to the terminal of an electric connector is a very fine wire (for example, American Wire Gauge size 36 falls in the category of very fine wire, and the diameter of this electric wire is 0.12 mm approximately.), the work of applying molten solder to the contacting parts of both the conductor of the very fine wire and the terminal of the electric connector can not be done by an automatic machine, and it is inevitable to do the work manually by a skilled worker. Hence the productivity is low and this results in an increase in cost. A similar problem will be encountered when a very fine wire is to be connected to the terminal of the electric connector by crimping or insulation displacement contact.

To produce the above-mentioned conventional electric connector, two processes, namely, the process of forming the housing and the process of plating, are required. Hence the connector can not be produced at a stroke.

Now, Japanese Patent unexamined publication gazette Heisei 10-237331 discloses a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal.

### SUMMARY OF THE INVENTION

This lead-free ultrahigh-conductive plastic exhibits high conductivity, for example, 10⁻³ Ω·cm or under in volume resistivity. Moreover, this material can be formed by injection molding and has a high degree of freedom in molding. Furthermore, as this material contains solder, there is no need of separately applying solder.

The present inventor contemplated to create electric connectors, which can solve the above-mentioned problems, by using the lead-free ultrahigh-conductive plastic, which has such excellent conductivity and moldability and contains solder. This lead-free ultrahigh-conductive plastic, however, is inferior in elasticity in comparison with metals or the like, and when it is used for a contacting part of the electric connector, it poses a difficulty in securing an adequate contact pressure between terminals.

One objective of the present invention is to solve the above-mentioned problems at a stroke by combining an electric connector, which uses the lead-free ultrahigh-conductive plastic, with a counterpart electric connector, which uses a highly elastic material such as metal for the terminals thereof.

To accomplish the above-mentioned objective, a pair of electric connectors using resin solder in one connector according to the present invention comprises a first electric connector and a second electric connector which fit with each other to connect with each other, wherein the first electric connector comprising a first housing, which is made of a synthetic resin, and a first terminal, which has a contacting part and a connecting part both being exposed on the surface of the first housing, is formed integrally with the first housing and is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal, and the second electric connector comprising a second housing, which is made of an insulating material, and a second terminal, which is made of a conductive material having a higher elasticity than that of the lead-free ultrahigh-conductive plastic, has a contacting part, which contacts the contacting part of the first terminal, and a connecting part, which is exposed on the surface of the second housing, and is provided with the second housing.

The production cost of the first electric connector can be reduced because it is not necessary to produce the electric contacts independently of the first housing. In that case, the lead-free ultrahigh-conductive plastic exhibits high conductivity, as high as 10⁻³ Ω·cm or under in volume resistivity. Hence the electric resistance of the first terminal can be lowered. Moreover, after the connection of the conductor of the electric wire or the like to the first terminal, when electricity is passed at a normal level, the lead-free ultrahigh-conductive plastic will not melt out due to heat generation. Further, in comparison with the technology of MID, wherein a conductive plated layer is formed on the surface of an insulator, the lead-free ultrahigh-conductive plastic provides the first terminal with a larger cross-sectional area and a larger volume. Hence the resistance of the conductor can be reduced and the heat dissipation is better. This in turn allows passage of a larger current.

As the lead-free ultrahigh-conductive plastic, which forms the first terminal, can be molded by injection molding, the first terminal has a greater freedom in molding than a terminal which is formed by MID. Moreover, the first housing is made of a synthetic resin. Hence the first terminal and the first electric connector can be molded into a variety of configurations according to their applications, and for example, differences in level, overhangs, etc. can be formed. This makes it easier to obtain impedance matching.

When the conductor of the electric wire or the like is placed on the connecting part of the first terminal and their contacting parts are heated, the lead-free solder being contained in the lead-free ultrahigh-conductive plastic will melt out and stick to the conductor. When the solder cools and solidifies, the conductor will be connected to the first terminal. Hence the conductor can be easily connected to a part which is difficult or impossible to solder, for example, a recess in the electric connector. As solder quality control, temperature control and the like are not required, the control man-hour is reduced correspondingly. Further, connection of a very fine wire can be done by an automatic machine, and the productivity is enhanced and the cost is reduced.

As the first electric connector can be produced at a stroke by multi-color injection molding or the like, its productivity is higher in comparison with an electric connector using terminals made by MID, which requires two processes, namely, the process of molding the housing and the process of plating.

As the second terminal is made of a conductive material of which elasticity is higher than that of the lead-free ultrahigh-conductive plastic, the contact pressure between the terminals can be secured by the elastic repelling force of the second terminal.

### BRIEF DESCRIPTION OF THE DRAWINGS

FIG. 1 is a perspective view of the first electric connector of the first embodiment according to the present invention.

FIG. 2 is a sectional view of the first electric connector of the first embodiment. The first connector is cut along the first terminal by a plane perpendicular to the width direction thereof.

FIG. 3 is a sectional view of the first electric connector of the first embodiment along a plane which is perpendicular to the front-rear direction. The plane cuts the body of the first housing.

FIG. 4 is a sectional view of the first electric connector of the first embodiment along a plane which is perpendicular to the front-rear direction. The plane cuts the protruding part of the first housing.

FIG. 5 is perspective view of the second electric connector of the first embodiment.

FIG. 6 is a sectional view of the second electric connector of the first embodiment along a plane which is perpendicular to the width direction.

FIG. 7 is a sectional view of the second electric connector of the first embodiment along a plane which is perpendicular to the front-rear direction.

FIG. 8 is a sectional view of the first electric connector and the second electric connector of the first embodiment in the state of being connected to each other. The electric connectors are cut along a plane which is perpendicular to the front-rear direction.

FIG. 9 is a perspective view of the first electric connector of the second embodiment.

FIG. 10 is a sectional view of the first electric connector of the second embodiment along a plane which is along the first terminal and perpendicular to the width direction.

FIG. 11 is a sectional view of the first electric connector of the second embodiment along a plane which is perpendicular to the front-rear direction.

FIG. 12 is a perspective view of the second electric connector of the second embodiment.

FIG. 13 is a sectional view of the second electric connector of the second embodiment along a plane which is perpendicular to the width direction.

FIG. 14 is a sectional view of the second electric connector of the second embodiment along a plane which is perpendicular to the front-rear direction.

FIG. 15 is a sectional view of the first electric connector and the second electric connector of the second embodiment in the state of being connected to each other. The electric connectors are cut along a plane which is perpendicular to the front-rear direction.

FIG. 16 is a schematic structural diagram of the lead-free ultrahigh-conductive plastic used in the embodiments.

FIG. 17 is a schematic structural diagram of the conventional plastic wherein powder of a metal that does not melt is kneaded in a resin.

### DESCRIPTION OF PREFERRED EMBODIMENTS OF THE INVENTION

In the following, some embodiments of a pair of electric connectors using resin solder in one connector according to the present invention will be described.

First, the above-mentioned lead-free ultrahigh-conductive plastic, which is commonly used in all the embodiments of the present invention, will be described in detail according to the description of Japanese Patent unexamined publication gazette Heisei 10-237331. This lead-free ultrahigh-conductive plastic is a conductive resin composite, which comprises a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal. This lead-free ultrahigh-conductive plastic includes those wherein lead-free solder parts that are finely dispersed in the above-mentioned thermoplastic resin are continuously connected to each other in the entire resin. The above-mentioned lead-free ultrahigh-conductive plastic includes those of which above-mentioned conductive resin composite has such a conductivity that

The synthetic resin to be used for this lead-free ultrahigh-conductive plastic is not specifically limited, and those that have been used conventionally can be used. However, from the viewpoints of ease in molding and some other physical properties required, it is preferable to use a thermoplastic resin.

The metal to be used for this lead-free ultrahigh-conductive plastic must be a lead-free metal that can half melt when the synthetic resin composite containing the metal is heat-plasticated. As the heat plastication temperature of thermoplastic resin is normally 350° C. or under, low-melting-point metals having a melting point below the above-mentioned plastication temperature are preferable. The metal may be a pure metal or an alloy. As the metal is kneaded under half-melted condition, its configuration is not limited particularly. However, a granular form or a powdery form of metal is preferable since it is easy to handle for dispersion.

Specific examples of the above-mentioned metal include zinc (Zn), tin (Sn), bismuth (Bi), aluminum (Al), cadmium (Cd), indium (In) and their alloys. Examples of preferred alloys among them include low-melting-point alloys such as Sn—Cu, Sn—Zn, Sn—Al and Sn—Ag.

Metals in powdery form for assisting dispersion of the solder include copper (Cu), nickel (Ni), aluminum (Al), chromium (Cr) and their alloys all in powdery form. The finer is the particle diameter of the metal powder, the finer is the dispersion of the solder after kneading. However, it is not necessary to provide powder of a common particle diameter. Powder of a metal having a distribution of particle diameters can be used. The usage of the metal components in the above-mentioned lead-free ultrahigh-conductive plastic is from 30 to 75% and preferably from 45 to 65% in volume ratio to the entire conductive resin composite.

The above-mentioned lead-free ultrahigh-conductive plastic uses a resin and a low-melting-point alloy (lead-free solder) which does not contain lead from the viewpoint of environment. As they are kneaded when the metal is kept in a half-melted state, the lead-free solder being metal components can be dispersed finely throughout the resin. Moreover, as kneading is made when the lead-free solder is kept under a half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence terminals and the like can be formed by processes of injection molding alone. Moreover, as no plating is required, a conductive part of low resistance can be formed inside the injection molding.

To produce the above-mentioned conductive resin composite, kneading machines and extruding machines for conventional resins can be used.

Next, embodiments of the above-mentioned lead-free ultrahigh-conductive plastic will be described.

### Embodiment 1

45% by volume of ABS resin (produced by Toray; Toyolac 441), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into a kneader (Moriyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by a plunger extrusion pelletizer (Toshin make, Model TP60-2) at the dies temperature ranging from 200 to 240° C. to produce pellets. These pellets were used to make injection molding into molds by an injection molding machine (Kawaguchi Tekko make, KS-10B). The preset temperature was from 230 to 280° C., and the mold temperature was from the ordinary temperature to 150° C. The injection moldings obtained showed no sign of segregation of metal, and their surfaces were even.

Observation, under an optical microscope, of the state of dispersion of the solder of this injection molding showed that the solder was evenly dispersed throughout the resin and solder fractions were about 5 μ in size. The volume resistivity of this specimen was on the order of 10⁻⁵Ω·cm.

### Embodiment 2

45% by volume of PBT resin (produced by Polyplastic), 40% by volume of lead-free solder (produced by Fukuda Kinzoku Hakufun Kogyo; Sn—Cu—Ni—AtW-150) and 15% by volume of copper powder (produced by Fukuda Kinzoku Hakufun Kogyo; FCC-SP-77, mean particle diameter 10 μm) were lightly mixed together and fed into the kneader (Moriyama Seisakusho make, double-screw pressurized type) which was set at 220° C. The mixture was kneaded, without preheating time, at a rate ranging from 25 to 50 r.p.m. for 20 minutes while efforts were made to prevent the temperature of the kneaded material from rising to 235° C. or over, by lowering the rate of revolution, cooling, etc.; the resin was heat-plasticated and the solder, under half-melted condition, was dispersed throughout the resin. Observation, under an optical microscope, of the state of dispersion of the solder of the kneaded material showed that the solder was evenly dispersed throughout the resin and solder fractions were about 5 μm in size.

### Embodiment 3

35% by volume of ABS resin (produced by Toray; Toyolac 441), 55% by volume of lead-free solder (produced by Fukuda Kinzoku Hakufun Kogyo; Sn—Cu—Ni—AtW-150) and 10% by volume of copper powder (produced by Fukuda Kinzoku Hakufun Kogyo; FCC-SP-77, mean particle diameter 10 μm) were lightly mixed together, and the total of the metal components was set at 65% by volume. Then the mixture was fed into the kneader (Morlyama Seisakusho make, double-screw pressurized type) which was set at 220° C. The mixture was kneaded, without preheating time, at a rate ranging from 25 to 50 r.p.m. for 20 minutes; the resin was heat-plasticated and the solder, under half-melted condition, was dispersed throughout the resin.

The kneaded material was pelletized by the plunger extrusion pelletizer (Toshin make, Model TP60-2) at the dies temperature ranging from 200 to 240° C. to produce pellets. These pellets were used to make injection molding into molds by the injection molding machine (Kawaguchi Tekko make, KS-10B). The preset temperature of the machine was from 230 to 280° C., and the mold temperature was from the ordinary temperature to 150° C. The injection moldings obtained showed no sign of segregation of metal, and their surfaces were even. Observation, under an optical microscope, of the state of dispersion of the solder showed that the solder was evenly dispersed throughout the resin and solder fractions were about 100 μm or under in size. The volume resistivity of this specimen was on the order of 4×10⁻⁵Ω·cm.

As clearly shown by the above-mentioned specific examples, the lead-free solder could be dispersed finely throughout the resins, and even when a large volume of metal components as high as 65% by volume were mixed, a kneaded material that did not show any segregation, under heating, of metals from the resin was obtained successfully. As the solder fractions were continuous to each other in this lead-free ultrahigh-conductive plastic, the conductivity of the plastic did not show any deterioration even when the temperature changed, thus the plastic stably exhibited high conductivity. In injection molding, the plastic was successfully molded into fine configurations without any clogging.

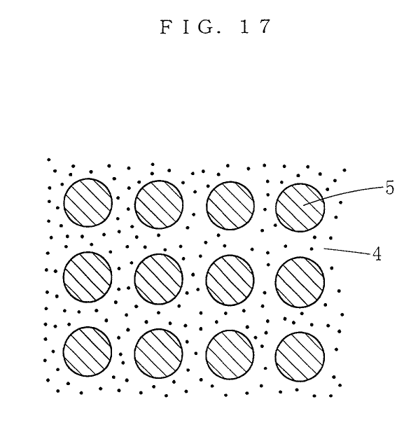

With the use of this lead-free ultrahigh-conductive plastic, terminals and the like having a three-dimensional configuration and low resistance can be formed by injection molding. In the following, with reference to the attached drawings, specific examples will be described in detail. FIG. 16 is a schematic structural diagram of the above-mentioned lead-free ultrahigh-conductive plastic. As shown in this diagram, in this lead-free ultrahigh-conductive plastic, the lead-free solders 1 are connected to each other by the solders 2 which are melted in the plastic 3. Hence the lead-free solders 1 are junctioned to each other and the conductivity is high and the reliability of the connection is high.

In contrast to this, as shown in FIG. 17, when powder 5 of a conventional metal that does not melt is kneaded in a plastic 4, the metal particles will not connect to each other unless a large amount of the metal content is mixed. Hence conductivity can not be obtained.

Thus the lead-free ultrahigh-conductive plastic shows a low resistance, does not exhibit deterioration in conductivity in a variety of environments, and has a high reliability.

To sum up, when a resin and a low-melting-point alloy (lead-free solder) which does not contain lead from the viewpoint of environment are used, and they are kneaded with the metal being kept in half-melted condition, the lead-free solder being the metal components can be dispersed finely throughout the resin. Moreover, as kneading is made when the lead-free solder is kept in half-melted condition, the dispersed solder fractions are kept connected continuously to each other. This connection is not just a contact but a junction between solder fractions. As the conductivity thus achieved differs from that obtained by contacts among metal fractions, even if the molding is heated to a high temperature, the junctions will not break, thus the molding stably exhibits low resistance.

When this material is to be formed by injection molding, as the metal components are partly half-melted and the lead-free solder is finely dispersed, the material can be formed by injection molding into fine configurations although the material contains a large amount of metal components. Hence terminals and the like can be formed by processes of injection molding alone. Moreover, as no plating is required, a conductive part of low resistance can be formed inside the frame (injection molding).

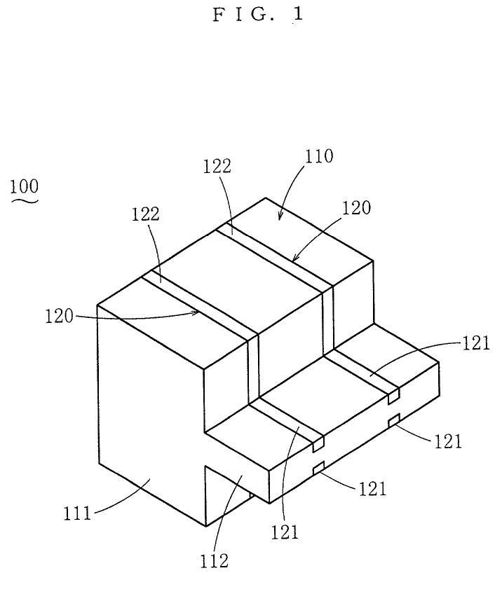

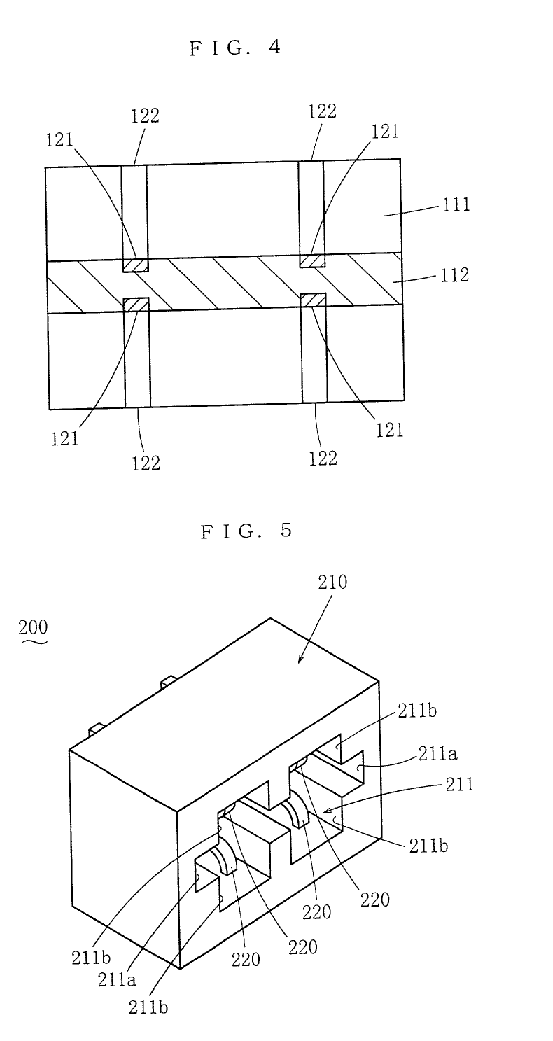

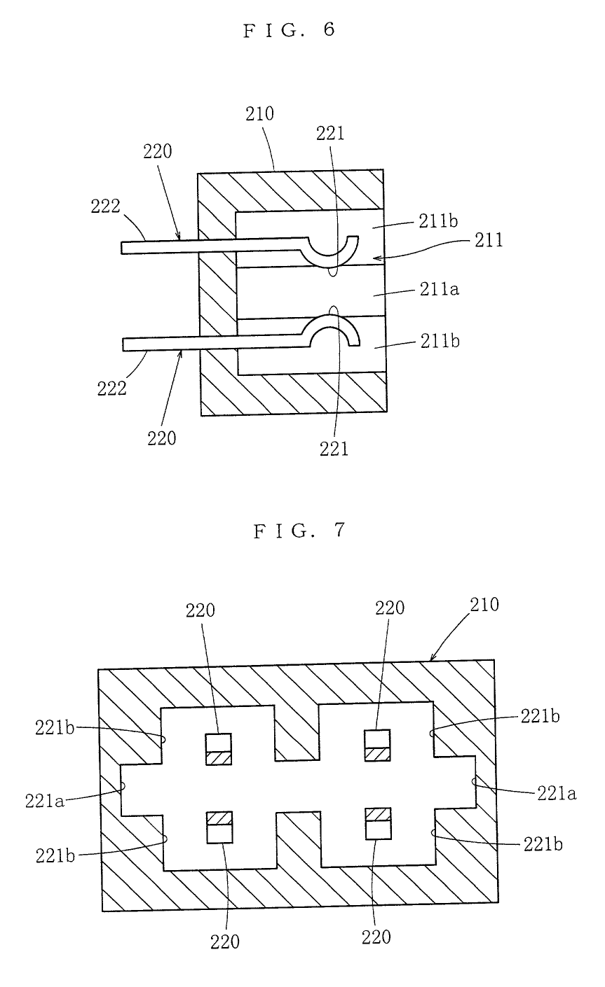

Next, the pairs of electric connectors using the resin solder in one connector of the embodiments will be described. FIG. 1 through FIG. 7 show the pair of electric connectors of the first embodiment. This pair of electric connectors comprise the first electric connector 100 of the male type and the second electric connector 200 of the female type. These electric connectors are fitted with each other to make mechanical and electric connections. The first electric connector 100 comprises a first housing 110 and first terminals 120, which are integrally formed with the first housing 110. The first terminal 120 has a contacting part 121 and a connecting part 122, which are exposed on the surface of the first housing 110. The first housing 110 is made of a synthetic resin, and the first terminal is made of the lead-free ultrahigh-conductive plastic being the conductive resin composite. The synthetic resin to be used for the first housing 110 is not limited specifically, and those that have been used conventionally can be used. However, from the viewpoints of ease in molding and some other physical properties required, it is preferable to use a thermoplastic resin. The second electric connector 200 comprises a second housing 210 and second terminals 220, which are provided with the second housing 210. The second terminal 220 has a contacting part 221, which contacts the contacting part 121 of the first terminal 120, and a connecting part 222, which is exposed on the surface of the second housing 210. The second housing 210 is made of an insulating material, for example, a synthetic resin. The second terminal 220 is made of a conductive material of which elasticity is higher than that of the above-mentioned lead-free ultrahigh-conductive plastic, such as metal, for example a copper alloy.

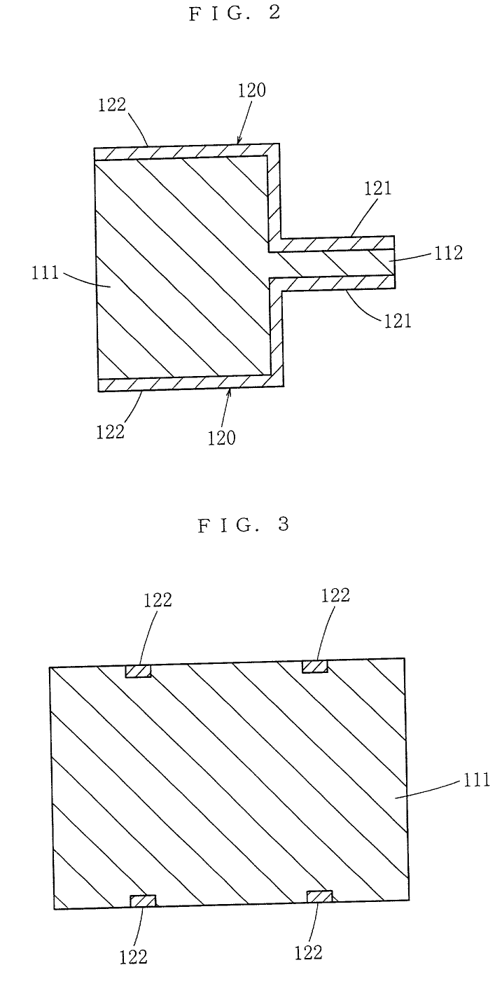

As shown in FIG. 1 through FIG. 4, the first housing 110 is provided with a body 111 and a protruding part 112, which protrudes from the body 111. In this embodiment, the body 111 is formed into a rectangular parallelepiped. For the convenience of description, the front-rear direction, width direction and height direction are defined along the respective sides of the body 111. The protruding part 112 is formed into a rectangular parallelepiped of which width dimension is identical to that of the body 111 and height dimension is smaller than that of the body 111, and the protruding part 112 is integrally formed on the front face of the body 111. The contacting part 121 of the first terminal 120 is exposed on the surface of the protruding part 112, and the connecting part 122 thereof is exposed on the surface of the body 111. As this embodiment exemplifies a four-pole electric connector, there are four first terminals 120. The first terminal 120 is formed into a bar of which section is rectangular, and it is fitted in a groove made on the surface of the first housing 110. As shown in FIG. 2, of the four grooves and their first terminals 120, two grooves and their first terminals 120 are provided on the top face of the protruding part 112 and the front face and the top face of the body 111 in a continuous manner. The other two grooves and their first terminals 120 are provided on the bottom face of the protruding part 112 and the front face and the bottom face of the body 111 in a continuous manner. The first electric connector 100 is molded by, for example, injection molding. In that case, the first housing 110 and the first terminals 120 are molded by multi-color injection molding which use the same molding machine.

As shown in FIG. 5 through FIG. 7, the second housing 210 has a cavity 211, which holds the second terminals 220 and into which the protruding part 112 of the first housing 110 is inserted. In this embodiment, the second housing 210 is formed into a rectangular parallelepiped. For the convenience of description, the front-rear direction, width direction and height direction are defined along the respective sides of the second housing 210. The cavity 211 opens in the rear face of the second housing 210, and has a central part 211a, into which the protruding part 112 is inserted, and expanded parts 211b which are formed on the upper side or the lower side of the central part 211a to expand the central part 211a. The expanded parts 211b are provided according to the number of the second terminals 220 in positions corresponding to those of the second terminals 220. The second terminal 220 is provided with the second housing 210 in such a way that when it is pushed by the protruding part 112, it will undergo elastic deformation and, due to its restoring force, contact the contacting part 121 of the first terminal 120. As this embodiment exemplifies a four-pole electric connector, there are four second terminals 220. The second terminal 220 is made to pierce the front wall of the second housing 210 and is fixed in the front wall. A cantilevered portion of the second terminal 220, which extends from the front wall into the cavity 211 and can undergo elastic deformation in the width direction, is the contacting part 221. A portion of the second terminal 220, which extends forwards from the front wall, is the connecting part 222.

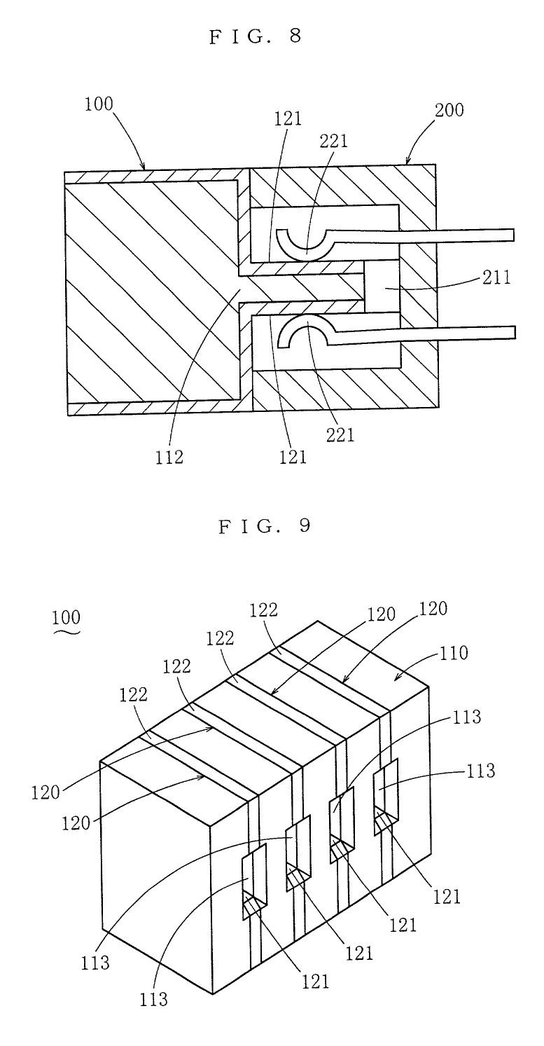

Accordingly, in the case of the pair of electric connectors of the first embodiment, as shown in FIG. 8, when an electric wire or the like is connected to the connecting part 122 of each first terminal 120 of the first electric connector 100, an electric wire or the like is connected to the connecting part 222 of each second terminal 220 of the second electric connector 200, and the protruding part 112 of the first electric connector 100 is inserted into the cavity 211 of the second electric connector 200, both connectors 100, 200 will be fitted together and the first terminals 120 and the second terminals 220 will contact each other at their contacting parts 121, 221, and in turn, both connectors 100, 200 will be connected to each other mechanically and electrically. As for the first electric connector 100, it is not necessary to produce electric contacts independently of the first housing 110, the production cost of the first electric connector 100 can be reduced.

In that case, the lead-free ultrahigh-conductive plastic exhibits high conductivity, as high as 10⁻³Ω·cm or under in volume resistivity. Hence the electric resistance of the first terminal 120 can be reduced. After the connection of the conductors of electric wires or the like to the first terminals 120, when electricity is passed at a normal level, the lead-free ultrahigh-conductive plastic will not melt out due to heat generation. Moreover, in comparison with the technology of MID wherein a conductive plated layer is formed on the surface of an insulator, the lead-free ultrahigh-conductive plastic provides the first terminal 120 with a larger cross-sectional area and a larger volume. Hence the resistance of the conductor can be reduced and the heat dissipation is better. This in turn allows passage of a larger current.

As the lead-free ultrahigh-conductive plastic, which forms the first terminal 120, can be molded by injection molding, it gives a higher degree of freedom in molding in comparison with a terminal formed by MID. Moreover, the first housing 110 is made of a synthetic resin. Hence the first terminals 120 and the first electric connector can be molded into a variety of configurations according to the applications, and for example, differences in level and overhangs can be formed. This makes it easier to obtain impedance matching.

When a conductor of an electric wire or the like is placed on the connecting part 122 of the first terminal 120 and their contacting parts are heated, the load-free solder being contained in the lead-free ultrahigh-conductive plastic of the first terminal 120 will melt out and stick to the conductor. When the solder cools and solidifies, the conductor will be connected to the first terminal 120. Hence a conductor can be easily connected to a part which it is difficult or impossible to solder, for example, a recess ill the electric contact. Moreover, as solder quality control, temperature control and the like are not required, the control man-hour is reduced correspondingly. Further, the connection of a very fine wire can be done by an automatic machine, and the productivity is enhanced and the cost is reduced. The above-mentioned heating is effected by, for example, blowing hot air or irradiating high frequency waves or laser beams to give thermal energy. Or electricity may be passed between the first terminal 120 and the conductor of the electric wire or the like by a power source to melt the lead-free solder being contained in the first terminal 120 and connect the conductor of the electric wire or the like to the first terminal 120.

As the first electric connector 100 can be produced at a stroke by multi-color injection molding or the like, the productivity is higher than that of the method using terminals made by MID, which requires two processes, namely, the process of molding the housing and the process of plating.

The second terminal 220 is made of a conductive material of which elasticity is higher than that of the lead-free ultrahigh-conductive plastic. Hence the contact pressure between the first terminal 120 and the second terminal 220 is secured by the elastic repelling force of the second terminal 220.

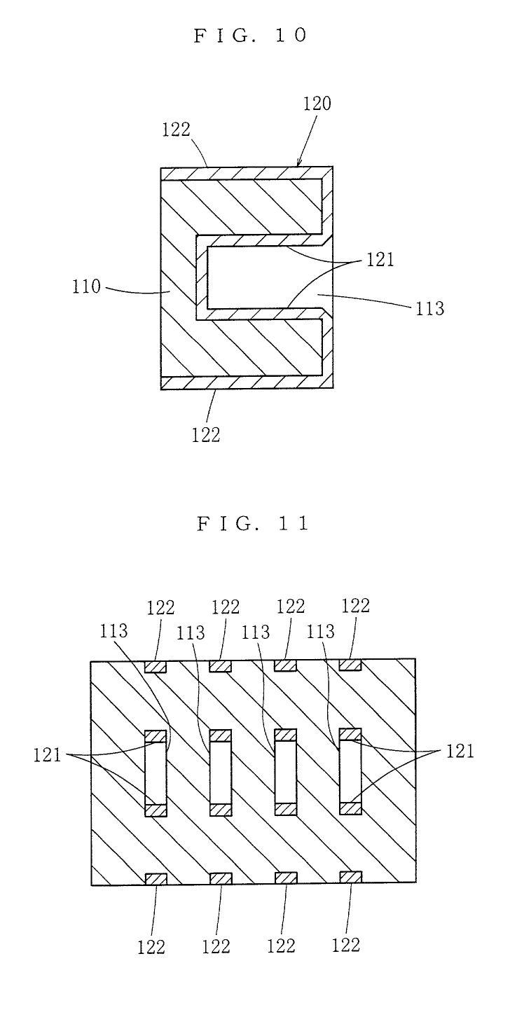

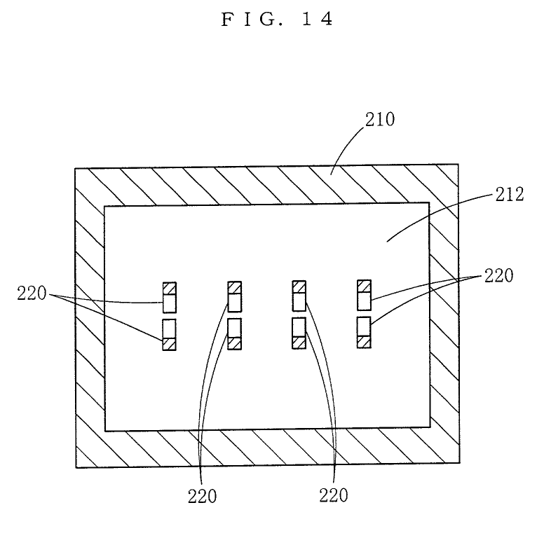

FIG. 9 through FIG. 14 show the pair of electric connectors of the second embodiment. In the first embodiment, the first electric connector is a male electric connector. In the second embodiment, the first electric connector is a female electric connector. The pair of electric connectors of the second embodiment comprise a first electric connector 100 of a female type and a second electric connector 200 of a male type, and they are fitted together to make mechanical and electrical connections. The first electric connector 100 comprises a first housing 110 and first terminals 120, which are integrally formed on the first housing 110. The first terminal 120 has a contacting part 121 and a connecting part 122, which are exposed on the surface of the first housing 110. The first housing is made of a synthetic resin, and the first terminal 120 is made of the lead-free ultrahigh-conductive plastic being the conductive resin composite. The second electric connector 200 comprises a second housing 210 and second terminals 220, which are provided with the second housing 210. The second terminal 220 has a contacting part 221, which contacts the contacting part 121 of the first terminal 120, and a connecting part 222, which is exposed on the surface of the second housing 210. The second housing 210 is made of an insulating material, for example, a synthetic resin. The second terminal 220 is made of a conductive material of which elasticity is higher than the above-mentioned lead-free ultrahigh-conductive plastic, such as a metal, for example, a copper alloy.

As shown in FIG. 9 through FIG. 11, the first housing 110 has a body 111 and concaved parts 113, which are concaved in the body 111. In this embodiment, the body 111 is formed to be a rectangular parallelepiped. For the convenience of description, the front-rear direction, width direction and height direction are defined by the respective sides of the body 111. The size of the opening of the concaved part 113 is just enough to receive the second terminals 220. In this embodiment, the concaved parts 113 are provided just for the number of sets of the second terminals 220, but they may be united to have one opening. The first terminal 120 is exposed on the surface of the concaved part 113, and the connecting part 122 is exposed on the surface of the body 111. As this embodiment exemplifies a four-pole electric connector, four first terminals 120 are provided. The first terminal 120 is formed into a bar of which section is rectangular, and is fitted in a groove formed on the surface of the first housing 110. As shown in FIG. 10, the first terminal 120 is provided on the top face and the upper part of the front face of the body 111, and the top face, rear face and bottom face of the concaved part 113, and the lower part of the front face and the bottom face of the body 111 in a continuous manner. The first electric connector 100 is molded by, for example, injection molding. In that case, the first housing 110 and the first terminals 120 are molded by multi-color injection molding, using the same molding machine.

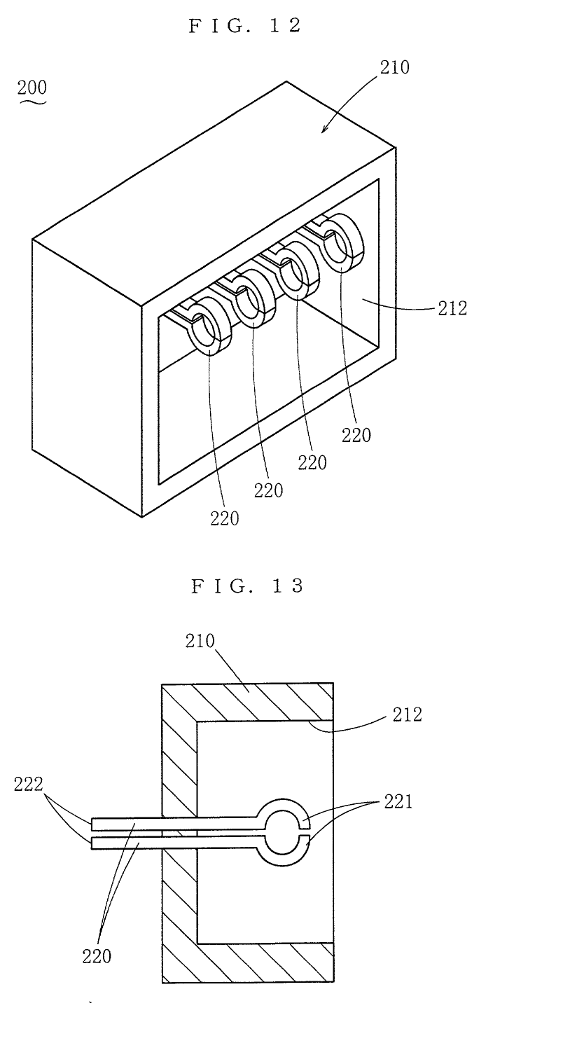

As shown in FIG. 12 through FIG. 14, the second housing 210 has a receiving hole 212, which holds the second terminals 220 and into which the first housing 110 is inserted. In this embodiment, the second housing 210 is formed into a rectangular parallelepiped. For the convenience of description, the front-rear direction, width direction and height direction are defined by the respective sides of the second housing 210. The receiving hole 212 opens on the rear face of the second housing 210, and the first housing 110 and the second housing 210 fit to each other, with the second housing 210 covering the outside of the first housing 110. The second terminal 220 is provided with the second housing 210 in such a way that when the second terminal 220 is inserted into the concaved part 113 and pushed by the concaved part 113, the second terminal 220 will undergo elastic deformation and, due to its restoring force, contact the contacting part 121 of the first terminal 120. As this embodiment exemplifies a four-pole electric connector, four sets of second terminals 220 are provided, with one set comprising two second terminals 220. The second terminals 220 are made to pierce the front wall of the second housing 210 and are fixed in the front wall. A cantilevered part of the second terminal 220, which extends into the receiving hole 212 from the front wall and can undergo elastic deformation in the height direction, is the contacting part 221, and a part extending forwards from the front wall is the connecting part 221.

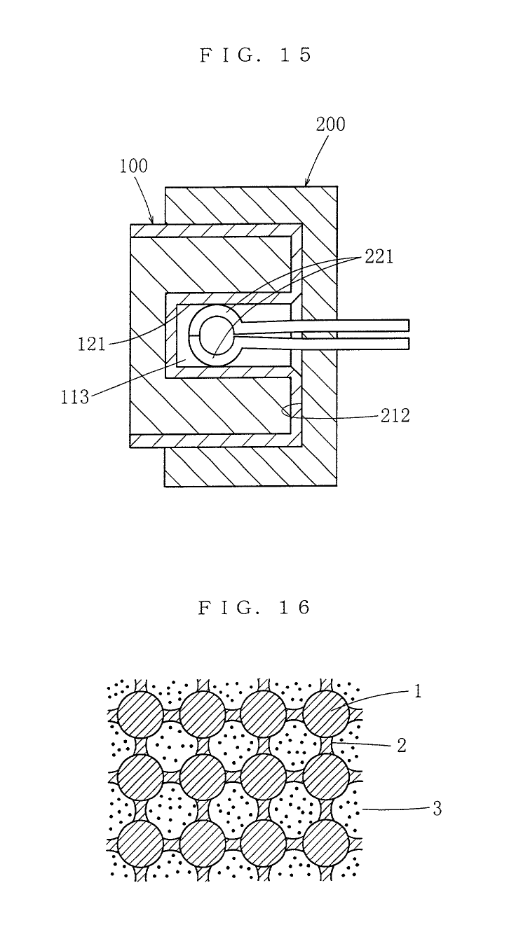

Accordingly, in the case of the pair of the electric connectors of the second embodiment, as shown in FIG. 15, when electric wires or the like are connected to the connecting parts 122 of the first terminals 120 of the first electric connector 100, electric wires or the like are connected to the connecting parts 222 of the second terminals 220 of the second electric connector 200, and the first electric connector 100 is inserted into the receiving hole 212 of the second electric connector 200, the second terminals 220 of the second electric connector 200 will be inserted into the concaved parts 113 of the first electric connector 100, both the connectors 100, 200 will be fitted together, and the first terminals 120 and the second terminals 220 will contact to each other at their contacting parts 121, 221, and in turn, both the connectors 100, 200 will make electrical and mechanical connections. As for the first electric connector 100, there is no need of producing electric contacts independently of the first housing 110. Hence the production cost of the first electric connector 100 can be reduced.

In that case, the lead-free ultrahigh-conductive plastic exhibits high conductivity, as high as 10⁻¹ Ω·cm or under in volume resistivity. Hence the electric resistance of the first terminal 120 can be reduced. After the connection of the conductors of the electric wires or the like to the first terminals 120, when electricity is passed at a normal level, the lead-free ultrahigh-conductive plastic will not melt out due to heat generation. Moreover, in comparison with the technology of MID, wherein a conductive plated layer is formed on the surface of an insulator, the lead-free ultrahigh-conductive plastic provides the first terminal 120 with a larger cross-sectional area and a larger volume. Hence the resistance of the conductor can be reduced and the heat dissipation is better. This in turn allows passage of a larger current.

As the lead-free ultrahigh-conductive plastic, which is to form the first terminal 120, can be molded by injection molding, it gives a higher degree of freedom in molding in comparison with terminals formed by MID. Moreover, the first housing 110 is made of a synthetic resin. Hence the first terminals 120 and the first housing 110 can be molded into a variety of configurations according to applications; for example, differences in level and overhangs can be formed. This makes it easier to obtain impedance matching.

When the conductors of electric wires or the like are placed on the connecting parts of the first terminals 120 and their contacting parts are heated, the lead-free solder being contained in the lead-free ultrahigh-conductive plastic of the first terminals 120 will melt out and stick to the conductors. When the solder cools and solidifies, the conductors will be connected to the first terminals 120. Hence a conductor can be easily connected to a part which it is difficult or impossible to solder, for example, a recess in an electric connector. Moreover, as solder quality control, temperature control and the like are not required, the control man-hour is reduced correspondingly. Further, the connection of a very fine wire can be done by an automatic machine, and the productivity is enhanced and the cost is reduced. The above-mentioned heating is effected by, for example, blowing hot air or irradiating high frequency waves or laser beams to give thermal energy. Or electricity may be passed between the first terminal 120 and the conductor of the electric wire or the like by a power source to melt the lead-free solder being contained in the first terminal 120 and connect the conductor of the electric wire or the like to the first terminal 120.

As the first electric connector 100 can be produced at a stroke by multi-color injection molding or the like, the productivity is higher than that of the method using terminals made by MID, which requires two processes, namely, the process of molding the housing and the process of plating.

As the second terminal 220 is made of a conductive material of which elasticity is higher than that of the lead-free ultrahigh-conductive plastic, the contact pressure between the first terminal 120 and the second terminal 220 is secured by the elastic repelling force of the second terminal 220.

The pair of electric connectors of the third embodiment are the pair of the electric connectors of the first embodiment or the second embodiment, wherein a plated layer for increasing the hardness is formed on the surface of the contacting part 121 of the first terminal 120 of the first electric connector 100. With this arrangement, the surface hardness of the first terminal 120 is increased, and even if the first terminal 120 is subjected to frictional forces, for example, by repeated insertion and extraction, its wear will be restrained. Thus the durability will be enhanced.

In the above-mentioned embodiments, the full length of the first terminal is exposed on the surface of the first housing, but it is sufficient for the first terminal only if at least the contacting part and the connecting part are exposed on the surface of the first housing. In the embodiment, the four-pole electric connectors were described. However, the number of poles of the electric connectors according to the present invention is not limited by this embodiment. The present invention includes all embodiments wherein features of the embodiments described above are combined.

With the description of these embodiments, the first pair of electric connectors using resin solder in one connector, which were described in the summary of the invention, have been fully described. Moreover, with the description of these embodiments, the second through fourth pairs of electric connectors using resin solder in one connector, which will be described below, have been fully explained.

The second pair of electric connectors using resin solder in one connector are the above-mentioned first pair of electric connectors using resin solder in one connector, wherein the first housing has a body and a protruding part, which protrudes from the body, the contacting part of the first terminal is exposed on the surface of the protruding part, the connecting part of the first terminal is exposed on the surface of the body, the second housing has a cavity, which holds the second terminal and into which the protruding part of the first housing is inserted, and the second terminal is provided with the second housing in such a way that when the second terminal is pushed by the protruding part, the second terminal will undergo elastic deformation and contact the contacting part of the first terminal due to the restoring force thereof.

With this arrangement, the first electric connector can be used as a male electric connector.

The third pair of electric connectors using resin solder in one connector are the above-mentioned first pair of electric connectors using resin solder in one connector, wherein the first housing has a body and a concaved part, which is concaved in the body, the contacting part of the first terminal is exposed on the surface of the concaved part, the connecting part of the first terminal is exposed on the surface of the body, the second housing has a receiving hole, which holds the second terminal and into which the first housing is inserted, and the second terminal is provided with the second housing in such a way that when the second terminal is inserted into the concaved part and pushed by the concaved part, the second terminal will undergo elastic deformation and contact the contacting part of the first terminal due to the restoring force thereof.

With this arrangement, the first electric connector can be used as a female electric connector.

The fourth pair of electric connectors using resin solder in one connector are any one of the above-mentioned first through third pairs of electric connectors using resin solder in one connector, wherein a plated layer for increasing the hardness is formed on the surface of the contacting part of the first terminal.

With this arrangement, the surface hardness of the contacting part of the first terminal is increased, and even if it is subjected to frictional forces due to repeated insertion or extraction, the wear will be restrained, and the durability will be enhanced.

What is claimed is:

1. A pair of electric connectors using resin solder in one connector, comprising a first electric connector and a second electric connector which fit with each other to connect with each other, wherein
the first electric connector comprising a first housing, which is made of a synthetic resin, and a first terminal, which has a contacting part and a connecting part both being exposed on the surface of the first housing, is formed integrally with the first housing and is made of a lead-free ultrahigh-conductive plastic being a conductive resin composite, comprising a thermoplastic resin, a lead-free solder that can be melted in the plasticated thermoplastic resin, and powder of a metal that assists fine dispersion of the lead-free solder in the thermoplastic resin or a mixture of the powder of the metal and short fibers of a metal, and
the second electric connector comprising a second housing, which is made of an insulating material, and a second terminal, which is made of a conductive material having a higher elasticity than that of the lead-free ultrahigh-conductive plastic, has a contacting part, which contacts the contacting part of the first terminal, and a connecting part, which is exposed on the surface of the second housing, and is provided with the second housing.

2. A pair of electric connectors using resin solder in one connector as recited in claim 1, wherein
the first housing has a body and a protruding part, which protrudes from the body,
the contacting part of the first terminal is exposed on the surface of the protruding part, and the connecting part of the first terminal is exposed on the surface of the body,
the second housing has a cavity, which holds the second terminal and into which the protruding part of the first housing is inserted, and
the second terminal is provided with the second housing in such a way that when the second terminal is pushed by the protruding part, the second terminal will undergo elastic deformation and contact the contacting part of the first terminal due to the restoring force thereof.

3. A pair of electric connectors using resin solder in one connector as recited in claim 1, wherein
the first housing has a body and a concaved part, which is concaved in the body,
the contacting part of the first terminal is exposed on the surface of the concaved part, and the connecting part of the first terminal is exposed on the surface of the body,
the second housing has a receiving hole, which holds the second terminal and into which the first housing is inserted, and
the second terminal is provided with the second housing in such a way that when the second terminal is inserted into the concaved part and pushed by the concaved part, the second terminal will undergo elastic deformation and contact the contacting part of the first terminal due to the restoring force thereof.

4. A pair of electric connectors using resin solder in one connector as recited in claim 1, wherein
a plated layer for increasing the hardness is formed on the surface of the contacting part of the first terminal.

5. A pair of electric connectors using resin solder in one connector as recited in claim 2, wherein
a plated layer for increasing the hardness is formed on the surface of the contacting part of the first terminal.

6. A pair of electric connectors using resin solder in one connector as recited in claim 3, wherein
a plated layer for increasing the hardness is formed on the surface of the contacting part of the first terminal.
